(19) United States
(12) Patent Application Publication
(10) Pub. No.: US 2008/0102362 A1
(43) Pub. Date: May 1, 2008

(54) Lead member and boding method thereof and nonaqueous electrolyte electricity storing device

(76) Inventors: Hiroaki Nii, Hyogo (JP); Kousuke Tanaka, Tochigi (JP); Koji Hanafusa, Tochigi (JP)

Correspondence Address: MCDERMOTT WILL & EMERY LLP, 600 13TH STREET, N.W., WASHINGTON, DC, 20005-3096, US

(21) Appl. No.: 11/707,258

(22) Filed: Feb. 16, 2007

(30) Foreign Application Priority Data
Oct. 25, 2006 (JP) P2006-290559

(51) Int. Cl. H01M 2/26

(52) U.S. Cl. 429/161

(57) ABSTRACT

A first member 11 and a second member 12 connected to each other are provided. The first member 11 is electrically connected to an electrode. The second member 12 is bonded to a position of the first member 11 remote from the electrode and is constituted by a material of a kind different from that of the first member 11. An overlapped portion 13 is formed at the first member 11 and the second member 12 and the overlapped portion 13 is bonded by cold welding. By the cold welding, the overlapped portion 13 is formed with a plurality of pressure marks 14 in a recess shape. Each cold pressure welded mark 14 is formed with a deformation mark reducing a depth of the cold pressure welded mark of the recess shape before plastic working by plastically working the overlapped portion 13 in a thickness direction thereof.

### BACKGROUND OF THE INVENTION

The present invention relates to a lead member and a bonding method thereof and a nonaqueous electrolyte electricity storing device. Particularly, the invention relates to a lead member excellent in a mechanical strength and an electric property and a bonding method thereof and a nonaqueous electrolyte electricity storing device.

In recent years, a reduction to practice of a nonaqueous electrolyte battery (for example, lithium ion battery or the like) has been progressed. A characteristic thereof resides in that in comparison with other battery, an energy output per unit volume or unit weight is high. Development of the nonaqueous electrolyte battery has been promoted as a power source of a mobile communication apparatus, a notebook personal computer, further, an electric vehicle or a hybrid vehicle. Particularly, small-sized formation, light-weighted formation of the battery as a power source has been requested, and attention is attracted to a nonaqueous electrolyte battery containing an electrode and an electrolysis solution or the like at inside of an external member mainly comprising a synthetic resin or the like.

Such a nonaqueous electrolyte battery is fabricated by fabricating an electrode group constituted by a laminated layer structure by, for example, laminating a positive electrode and a negative electrode by way of a separator, containing the electrode group in an external member, thereafter, sealing an electrolysis solution at inside of the external member. The positive electrode and the negative electrode are provided with a structure in which, for example, an active material layer is formed on a metal base member constituting a collector. Al is used for the metal base member of the positive electrode, Cu is used for the metal base member of the negative electrode frequently. Further, a structure of interposing a metal layer between plastic films is frequently used for the external member.

It is general that the metal base members of the positive electrode and the negative electrode are respectively connected with lead members and the lead members are led out from the external member as output terminals of electric energy. Al is used for the lead member connected to the positive electrode (positive electrode lead), Ni or Cu is used for the lead member connected to the negative electrode (negative electrode lead) frequently.

According to the battery having such a constitution, when desired electric energy is obtained by connecting a plurality of the batteries in series, it is necessary to constitute a battery set by bonding the positive electrode lead of one battery and the negative electrode lead of other battery. However, when the respective lead members are constituted by different metal materials, there poses a problem that a local battery is formed between the different kinds of metals at a bonded portion with an electrolysis solution constituted by water of condensation or the like, and the metal having a higher ionization tendency is corroded. Further, when corrosion is brought about at the lead member, a contact resistance of the bonded portion is increased, and not only the electric property is deteriorated but also the mechanical strength at the bonded portion is deteriorated.

A technology of resolving the problem is disclosed in, for example, Patent Reference 1. According to the technology described in the reference, a negative electrode lead is made of a copper plate, and a positive electrode lead is made of an aluminum plate and a copper plate. Thus, bonding of the positive electrode lead and the negative electrode lead can be constituted by a bonding between the copper plates, even when a battery set is constituted by connecting a plurality of batteries in series. Here, a bonded portion of the aluminum plate and the copper plate is coated by a coating resin to be blocked from outside air, and therefore, corrosion by forming a local battery is not brought about. Further, it is proposed to use ultrasonic welding or laser welding for bonding the aluminum plate and the copper plate.

Otherwise, for example, in Patent Reference 2, it is proposed to use cold welding other than ultrasonic welding as a method of bonding an electrode terminal of one battery and an electrode terminal of other battery when a battery set is constituted by connecting a plurality of batteries in series or in parallel.

### [Patent Reference 1] JP-A-2005-19213 (FIGS. 2, 3)

### [Patent Reference 2] JP-A-2005-340005 (paragraph 0026)

However, when laser welding for locally melting a metal by irradiating laser light is used, a fragile alloy layer is formed at a bonding boundary. Therefore, there is a concern that a mechanical strength against tension or vibration at the bonded portion is low and the electric property is deteriorated. Further, according to ultrasonic welding or the like, energy consumption is large, a facility thereof is large-scaled, operation thereof is complicated, and therefore, a fabrication performance is poor.

Further, although Patent Reference 2 discloses the use of cold welding, it is not described at all specifically under what condition the cold pressure welding is carried out, the different kinds of metals are preferably bonded. Particularly, a cold welding condition preferable for the lead member is not suggested at all.

### SUMMARY OF THE INVENTION

Therefore, it is an object of the invention to provide a lead member having a sufficient bonding strength mechanically and preventing a contact resistance at a bonded portion from being increased in a lead member bonded with a first member and a second member having different kinds of materials electrically and a method of bonding the lead member and a nonaqueous electrolyte electricity storing device.

The invention achieves the above-described object by bonding a first member and a second member of different materials by cold pressure welding and further compressing a cold pressure welded portion, and thereby constituting a lead member.

According to the invention, there is provided a lead member including:

a first member electrically connected to an electrode, and

a second member bonded to the first member at a position remote from the electrode and having a material different from the material of the first member, wherein

the first member and the second member overlap with each other,

an overlapped portion thereof are provided with a plurality of cold pressure welded marks in a recess shape formed by cold welding, and

each of the cold pressure welded marks is formed with a deformation mark wherein a depth of the cold pressure welded marks in the recess shape is reduced by plastic working the overlapped portion in a thickness direction thereof.

According to the constitution, the plurality of cold pressure welded marks are formed on the overlapped portion of the first member and the second member made of different metal materials, and a high bonding strength can be achieved. When cold welding is used, an alloy layer is difficult to be formed at a bonding interface, and a mechanical strength against tension or vibration at the bonding portion is high. Therefore, the bonding portion has a high resistance against environment change, and an aging change is small. Further, by using cold welding, an oxide film or the like formed at a surface of a metal material constituting the first member or the second member can sufficiently be pressed to destruct into small broken pieces, and the broken pieces can be dispersed in wide intervals at the bonding interface. Thereby, metal structures can be subjected to interatomic bonding without substantially interposing the oxide film or the like at a bonding interface, and an increase in a contact resistance at the bonding portion is hardly observed. Particularly, in cold welding, an amount of energy consumption is small, a facility is simple and operation is facilitated, and therefore, fabrication performance is excellent.

Further, each of the cold pressure welded marks is formed with a deformation mark. A depth of the cold pressure welded mark in a recess shape is reduced by being plastically worked. In other words, a plastic working lessens a stepped difference between a recess and a projection of a surface at the overlapped portion, and the surface of the overlapped portion is flattened. Therefore, when a corrosion resistant member, mentioned later, is coated on an outer periphery of the overlapped portion, a defect of a cavity or the like is difficult to be brought about between the corrosion resistant member and the overlapped portion, and the corrosion resistant member is easy to be brought into close contact with the surface of the overlapped portion.

According to a mode of the lead member of the invention, it is preferable that end portions of all of the cold pressure welded marks are arranged in parallel to be aligned in a width direction of the lead member.

By arranging the respective cold pressure welded marks in this way, a length (lap margin) of the overlapped portion in a longitudinal direction (electricity conducting direction) of the lead member can be shortened.

According to a mode of the lead member of the invention, it is preferable that both end portions of at least a cold pressure welded mark is shifted from both end portions of another cold pressure welded mark in a longitudinal direction of the lead member.

According to the cold pressure welded mark formed by cold welding, a portion thereof is extremely thinner than a portion which is not subjected to pressure welding. Therefore, stresses are liable to be concentrated on the both end portions of the cold pressure welded mark by tension or vibration and the both end portions are easy to constitute onsets of breakage. Particularly, when the both end portions of the respective cold pressure welded marks are aligned, in a case in which a distance between the contiguous cold pressure welded marks is short, when a crack is brought about at a certain cold pressure welded mark, the crack is liable to be propagated to both end portions of the contiguous cold pressure welded mark, and there is a concern of breaking the lead member per se finally in the width direction. Therefore, when the both end portions of at least a cold pressure welded mark is shifted from the both end portions of another cold pressure welded mark in the longitudinal direction of the lead member, the crack is prevented from being propagated, and the lead member can be restrained from being broken.

As specific examples of a method of shifting the both end portions of the cold pressure welded mark, there are pointed out (1) the respective cold pressure welded marks are arranged in a zigzag shape in the longitudinal direction of the lead member, (2) the respective cold pressure welded marks are constituted by shapes having longitudinal directions, and the cold pressure welded marks having different lengths in the longitudinal directions are alternately aligned in the width direction of the lead member.

According to a mode of the lead member of the invention, it is preferable that the respective cold pressure welded marks are constituted by shapes having longitudinal directions, and the longitudinal directions of the respective cold pressure welded marks are inclined to a longitudinal direction of the lead member.

By the constitution, a bonding strength can be increased by sufficiently ensuring a press contact area of the overlapped portion. Further, since the longitudinal directions of the respective cold pressure welded marks are not in parallel with the longitudinal direction of the lead member, the lap margin can be made to be shorter than that in the case in which the longitudinal directions are in parallel with the longitudinal direction of the lead member.

According to a mode of the lead member of the invention, it is preferable that the deformation mark is in a wavy shape of a bottom portion of the cold pressure welded mark in a section of the overlapped portion.

When the bottom portion of the cold pressure welded mark is formed in the wavy shape at the section of the overlapped portion, the depth and the opening width of the cold pressure welded mark in the recess shape are reduced in comparison with the depth and the opening width thereof before being subject to plastic working, and an angle of inclination of an inner wall of the cold pressure welded mark in the recess shape is made to be further proximate to a horizontal direction. In accordance therewith, a surface of the overlapped portion can further be flattened. Therefore, when the corrosion resistant member, mentioned later, is coated to the outer periphery of the overlapped portion, a cavity is difficult to be brought about between the corrosion resistant member and the overlapped portion, and the corrosion resistant member is easy to be brought into close contact with the surface of the overlapped portion.

According to a mode of the lead member of the invention, there is provided the lead member, wherein

the cold pressure welded marks include a first cold pressure welded mark on a surface of the first member and a second cold pressure welded mark on a surface of the second member.

In this case, the deformation marks include first closed marks of the first pressure marks and second closed marks of the second pressure marks which are aligned on the surface of the first member and the second member respectively, and the second closed marks of the second cold pressure welded marks are aligned at positions in correspondence with intervals between the first cold pressure welded marks. Further, it is preferable that an engaging portion is provided on the interval between the first closed marks and the second closed marks, for mechanically fitting the first member and the second member.

By plastically working the overlapped portion in a thickness direction thereof, a thickness of the overlapped portion after having been plastically worked can be made to be proximate to a thickness of the first member or the second member before being subjected to cold pressure welding, and a surface of the overlapped portion can be flattened. Further, by closing a bottom portion of the cold pressure welded mark which is liable to constitute an onset of breakage, a thin-walled portion can be reduced. Further, by providing the engaging portion for mechanically fitting the first member and the second member, there is constituted a structure of mechanically fitting the first member and the second member at the overlapped portion, and the bonding strength can further be increased.

According to a mode of the lead member of the invention, it is preferable that an outer periphery of the overlapped portion is coated with a corrosion resistant member, the corrosion resistant member includes: a thermoplastic layer adhered to the overlapped portion and including a thermoplastic polyolefin resin, and a bridging layer arranged on the thermoplastic layer and including a bridged polyolefin resin.

By coating the outer periphery of the overlapped portion with the corrosion resistant member, water or the like is prevented from invading the overlapped portion of the first member and the second member comprising different metals, and corrosion caused by forming a local battery can be restrained. Further, the corrosion resistant member includes the thermoplastic layer comprising the thermoplastic polyolefin resin at the adhering face with the overlapped portion, and can be brought into close contact with the surface of the overlapped portion by being melted by heating.

According to a mode of the lead member of the invention, when a positive electrode includes aluminum, it is preferable that the first member includes aluminum and the second member includes copper.

By using Al for the first member, the first member and an Al base member of the positive electrode are constituted by the same kind of metal, and bonding of the first member and the positive electrode is facilitated. Further, Cu is frequently used for a negative electrode lead. In that case, by using Cu for the second member, the second member and the negative electrode lead are constituted by the same kind of metal, and bonding of the positive electrode lead and the negative electrode lead are constituted by bonding of the same metals. Cu subjected to Ni plating may be used for the second member.

Further, according to a mode of the lead member of the invention, when a negative electrode includes copper, it is preferable that the first member includes copper and the second member includes aluminum.

By using Cu for the first member, the first member and a Cu base material of the negative electrode are constituted by the same kind of metal, and bonding of the first member and the negative electrode is facilitated. Further, Al is frequently used for the positive electrode lead. In this case, by using Al for the second member, the second member and the positive electrode lead are constituted by the same kind of metal, and bonding of the negative electrode lead and the positive electrode lead are constituted by bonding of the same metals. Cu subjected to Ni plating may be used for the first member.

Otherwise, according to a mode of the lead member of the invention, it is preferable that the first member and the second member are bonded to form a nonlinear line shape.

It is not necessary that the first member and the second member are formed in a linear line shape to be bonded. When a battery set is constituted by connecting a positive electrode lead of a certain electricity storing device and a negative electrode lead of other electricity storing device in series, there is also conceivable a case in which the two electricity storing devices are aligned transversely or in a skewed direction. In that case, when both of the positive electrode lead and the negative electrode lead are constituted by lead members in a linear line shape, it is necessary to further prepare other conductive member for bonding the both. In contrast thereto, when the first member and the second member are bonded in a nonlinear shape, that is, in a direction of inclining the second member relative to the first member, the lead members of the electricity storing devices aligned transversely or in the skewed direction can directly be overlapped to be bonded.

On the other hand, a method of bonding a lead member of the invention is a method of bonding a lead member for bonding a first member electrically connected to an electrode and a second member having a material different from a material of the first member, and is characterized in comprising the following steps;

a step of overlapping the second member on the first member at a position remote from the electrode;

a step of subjecting an overlapped portion thereof to cold welding by a pair of dies at least one of which includes a plurality of projected portions to form a plurality of cold pressure welded marks in a recess shape on the lead members; and

a flattening step of reducing a depth of the cold pressure welded mark by plastically working the overlapped portion in a thickness direction thereof.

As described above, by using cold welding, there can be formed the bonding portion in which a mechanical strength against tension or vibration is high, and an increase in a contact resistance at the bonding portion is hardly observed. Further, by providing the flattening step, the thickness of the overlapped portion can be reduced and the surface of the overlapped portion can be flattened.

According to a mode of the bonding method of the invention, it is preferable that the flattening step comprises compressing the overlapped portion by a plane die.

The flattening step using the plane die facilitates operation and is excellent in production efficiency of the lead member.

According to a mode of the bonding method of the invention, it is preferable that respectives of the dies include pluralities of projected portions, and the cold welding step is carried out such that the projected portions of the respective dies are brought into a state of being shifted from each other.

By compressing the overlapped portion by using the pair of dies respectively having the projected portions in this way, the surface of the first member is formed with the first cold pressure welded mark and the surface of the second member is formed with the second cold pressure welded mark. Further, by the flattening step, the first closed marks of the first cold pressure welded marks are aligned on the surface of the first member, the second closed marks of the second cold pressure welded marks are aligned on the surface of the second member at positions in correspondence with the intervals between the first cold pressure welded marks, and the interval between the first closed marks of the first cold pressure welded marks and the second closed marks of the second cold pressure welded marks is formed with the engaging portion for mechanically fitting the first member and the second member.

Otherwise, there is provided a nonaqueous electrolyte electricity storing device, including a positive electrode, a negative electrode and a nonaqueous electrolyte medium contained in an external member, respective lead members electrically connected to respectives of the positive electrode and the negative electrode being led out from the external member to outside, wherein

at least one of the lead member of the invention is used, and

tips of both leads from the external members include the same material.

By constituting one of the lead members of the invention, and arranging the second member of the lead member at outside of the external member, the tip of the positive electrode lead and the tip of the negative electrode lead led out from the external member are substantially constituted by the same material. Therefore, when the devices are connected in series, a local battery is not formed at the portion of bonding the positive electrode lead and the negative electrode lead. Further, bonding of the positive electrode lead and the negative electrode lead can easily be carried out. When components of materials constituting the second member of the lead member connected to one electrode and other lead member are the same, the tip of the positive electrode lead and the tip of the negative electrode lead are the same material. Particularly, in a case of an alloy, a material not only having the completely same composition but also having the same elements constituting base materials of the alloy is made to constitute the substantially same material mentioned here.

According to a mode of the nonaqueous electrolyte electricity storing device of the invention, it is preferable that an outer periphery of the overlapped portion is coated with a corrosion resistant member. The corrosion resistant member includes: a thermoplastic layer adhered to the overlapped portion and including a thermoplastic polyolefin resin, and a bridging layer arranged on the thermoplastic layer and including a bridged polyolefin resin. Further, the corrosion resistant member is extended to a portion where the lead member and the external member are in contact with each other, and is welded to an inner face of the external member for preventing the nonaqueous electrolyte medium from leaking from the external member.

By extending the corrosion resistant member to the portion of bringing the corrosion resistant member and the external member into contact with each other and welding the corrosion resistant member to the inner face of the external member, not only water or the like can be prevented from invading the overlapped portion to bring about electric corrosion but also the nonaqueous electrolyte medium contained at inside of the external member can be prevented from being leaked. Further, the corrosion resistant member is provided with an insulating property and can sufficiently prevent the lead member and a metal sheet constituting the external member from being short circuited.

The lead member of the invention is provided with a mechanically sufficiently bonding strength and an increase in an electric contact resistance at the bonding portion is not substantially brought about.

According to the nonaqueous electrolyte electricity storing device of the invention, the bonding portion of the positive electrode lead and the negative electrode lead led out from the external member can be constituted by the same material, when the devices are connected in series, a local battery is not formed at the bonding portion of the positive electrode lead and the negative electrode lead.

### BRIEF DESCRIPTION OF THE DRAWINGS

FIG. 1A is a plane view showing an example of a lead member according to the invention, FIG. 1B is a side view showing the example of the lead member according to the invention.

FIG. 2A is a plane view of an inclined teeth die, FIG. 2B is a sectional view taken along a line A-A thereof.

FIGS. 3A and 3B show modes of dies having projected portions, FIG. 3A is a plane view showing an oval shape projected portion, FIG. 3B is a plane view showing a ship-like shape projected portion.

FIGS. 4A and 4B show modes of dies having projected portions, FIG. 4A is a plane view of a die aligned with a plurality of projected portions having the same size in a zigzag shape, FIG. 4B is a plane view of a die alternately aligned with pluralities of projected portions having two kinds of sizes.

FIGS. 5A to 5C show an example of a bonding method according to the invention, FIG. 5A is a sectional view of a portion showing an overlapped portion of a first member and a second member before being subjected to cold pressure welding, FIG. 5B is a schematic sectional view showing a state of subjecting the overlapped portion of the first member and the second member to pressure welding by a pair of dies having projected portions, FIG. 5C is a schematic sectional view showing a state of compressing the first member and the second member by a pair of plane dies after cold pressure welding.

FIG. 6 shows an example of a lead member according to the invention and is a schematic sectional view showing a mode of the first member and the second member after a flattening step by FIG. 5C.

FIG. 7 is a schematic disassembled perspective view of a lithium battery according to the invention.

FIG. 8 is a schematic plane view showing a state of aligning to bond lithium batteries according to the invention.

FIG. 9 is a schematic plane view showing a modified example of a structure of bonding batteries of FIG. 8.

FIG. 10 is a schematic plane view showing a state of vertically aligning lithium batteries according to the invention and aligning to bond vertically aligned groups thereof.

FIG. 11 is a schematic plane view showing a modified example of the structure of bonding batteries of FIG. 9.

FIG. 12 is an outline constitution view of an electrical double layer capacitor.

FIG. 13A is a schematic plane view of a lead member subjected to pressure welding by a straight die, FIG. 13B is a schematic plane view of the lead member subjected to pressure welding by a lengthwise teeth die, FIG. 13C is a schematic plane view of a lead member subjected to pressure welding by an inclined teeth die.

FIG. 14A is a photograph of a plane of a cold pressure welded mark subjected only to cold welding, FIG. 14B is a photograph of a section of the cold pressure welded mark.

FIG. 15A is a photograph of a plane of a cold pressure welded mark subjected to cold welding and a flattening step, FIG. 15B is a photograph of a section of the cold pressure welded mark.

FIG. 16 is an explanatory view showing an electricity conduction test method of a lead member.

FIG. 17A is a graph showing a relationship between an electricity conducting time period and a temperature rise of a sample subjected to cold welding and flattening, FIG. 17B is a graph of a sample subjected to ultrasonic welding.

### DETAILED DESCRIPTION OF THE PREFERRED EMBODIMENTS

Constitution requirements of the invention will be explained in further details as follows. Further, in the drawings, the same notations designate the same objects.

### <Lead Member>

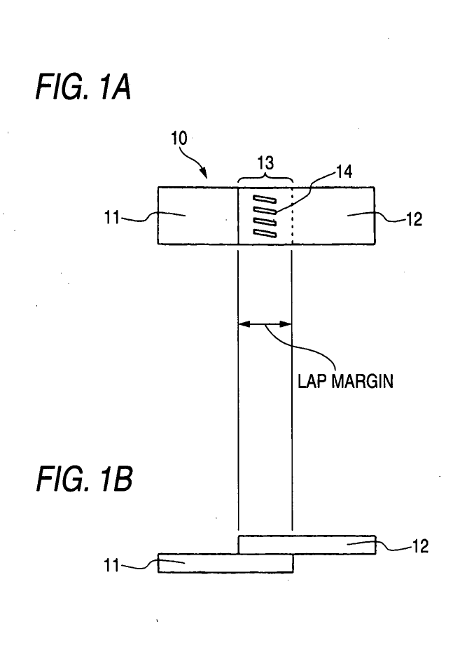

FIG. 1 shows a lead member of the invention, FIG. 1A shows a plane view, FIG. 1B shows a side view, respectively. A lead member 10 of the invention includes a first member 11 and a second member 12. The second member overlaps the first member. A portion of the second member at which the second member overlaps on the first member is called an overlapped portion of the second member. A portion of the first member at which the first member is overlapped is called an overlapped portion of the first member. The overlapped portions 13 are subjected to cold pressure welding, and a plurality of cold pressure welded marks 14 in a recess shape are formed thereon, and thereby the first member and the second member are bonded. Further, a deformation mark is formed by plastically working the overlapped portion formed with the cold pressure welded mark in a thickness direction.

(First Member)

The First member 11 is a member electrically connected to an electrode and is constituted by a metal material. There is preferably used the first member 11 of the lead member 10 connected to a positive electrode comprising Al, Ti, or an alloy of these. In this case, the first member performs as a positive electrode lead. Further, there is preferably used the first member 11 of the lead member 10 connected to a negative electrode comprising Al, Cu, or an alloy of these. In this case, the first member performs as a negative electrode lead. The first member 11 is brought into contact with an electrolyte medium at inside of an electricity storing device, and therefore, in order to promote corrosion resistance, a surface thereof is preferably provided with a corrosion resistant coating layer by subjecting the surface to a corrosion resistant treatment of alumina treatment, titania treatment, oxidation treatment, hydrooxidation treatment, boehmite treatment, chromate treatment, Ni plating or the like.

Various shapes of a shape of a circular pillar, a shape of a square pillar, a shape of a plate can be utilized for a shape of the first member 11. According to the invention, the overlapped portion 13 is formed and cold welding is carried out, and therefore, it is preferable to use a first member having a shape of a plate, or a first member having an overlapped portion only which is formed to a shape of a plate.

A dimension of the first member 11 may pertinently be determined, for example, when a shape of a plate is constituted, it is conceivable to constitute a width of 6 through 150 mm, a thickness of 0.08 through 3.0 mm. Particularly, it is further preferable to constitute a width of 15 through 100 mm, a thickness of 0.2 through 1.0 mm in consideration of carrying out cold welding.

(Second Member)

The second member 12 is a member connected to a position of the first member 11 at a position remote from the electrode and is constituted by a metal material different from that of the first member 11. There is preferably used the second member 12 of the lead member 10 connected to a positive electrode comprising Al, Cu, or an alloy of these and a surface thereof may be subjected to Ni plating. Further, there is preferably used the second member 12 of the lead member 10 connected to a negative electrode comprising Al, Ti, or an alloy of these, and a surface thereof may be subjected to the above-described corrosion resistant treatment.

Various shapes of a shape of a circular pillar, a shape of a square pillar, a shape of a plate can be utilized for the shape of the second member 12. It is preferable to use a second member having a shape of a plate, or a second member having an overlapped portion only which is formed to a shape of a plate. A dimension of the second member 12 may pertinently be determined, and it is conceivable to constitute a dimension the same as that of the first member 11. When conductivities of the first member 11 and the second member 12 differ from each other, voltage drop, energy loss may be reduced by thickening the member having a low conductivity.

Particularly, a lead member connected to one electrode includes a first member and a second member, and a lead member connected to other electrode may be constituted by one kind of metal material. Further, bonding of a positive lead and a negative lead is facilitated by constituting a second member of one lead member and the other lead member by substantially same material and bonding the second member and the other lead member.

(Overlapped Portion)

The overlapped portion 13 is formed by overlapping the first member 11 and the second member 12 in an up and down direction partially in a longitudinal direction. A length (lap margin) of the overlapped portion 13 in the longitudinal direction of the lead member may pertinently be determined such that an area to be subjected to pressure welding can sufficiently be ensured. However, when the lap margin is prolonged, it is necessary to prolong the first member 11 or the second member 12 by that amount. A preferable range of the lap margin is 3 through 30 mm, further preferably, 5 through 15 mm.

Further, when the overlapped portion 13 is formed, it is preferable to arrange a harder one of the first member 11 and the second member 12 on an upper face side. The upper face side of the overlapped portion 13 is arranged to be opposed to a die having a projected portion mentioned later in being subjected to cold welding and is compressed by the die having the projected portion. By arranging hard member on the upper face side, a portion thereof compressed by the projected portion on the upper face side is brought into a member on a lower face side, and the members on the upper face side and the lower face side can firmly and solidly be bonded.

### <Cold Welding>

Cold welding is carried out by pinching and strongly pressing the overlapped portion 13 of the first member 11 and the second member 12 by a pair of dies. When cold welding is used, metal structures of materials constituting the first member 11 and the second member 12 can be subjected to interatomic bonding by pressing to destruct sufficiently not only oxide films formed at surfaces of the first member 11 and the second member 12 but also corrosion resistant layers of Ni plating or the like.

(Pressure Welding Die)

As dies used in the invention, a combination of a die having a plurality of projected portions and a plane die, or a combination of dies each having a plurality of projected portions is conceivable.

The combination of the dies having the plurality of projected portions and the plane die can practically be utilized the most. An overlapped portion compressed by the combination is formed with a cold pressure welded mark of a deep recess shape on an upper face side compressed by the projected portion.

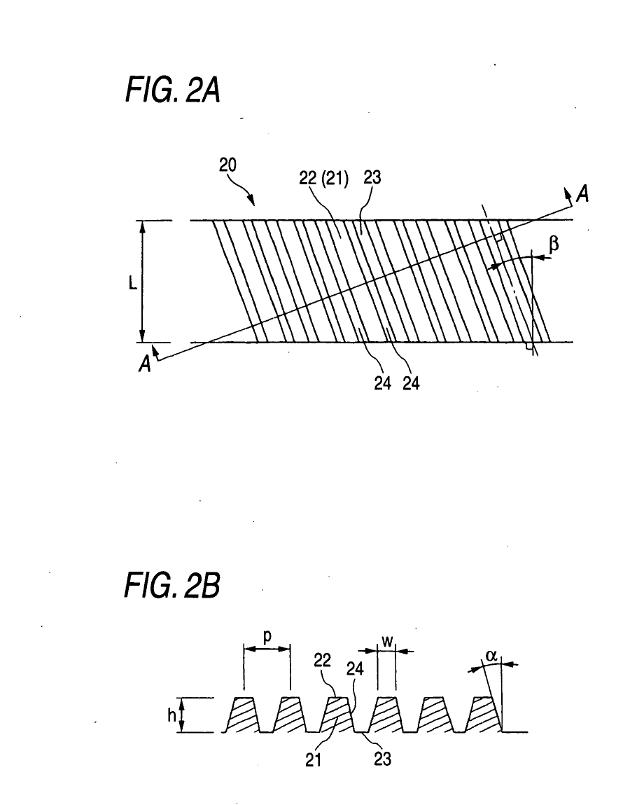

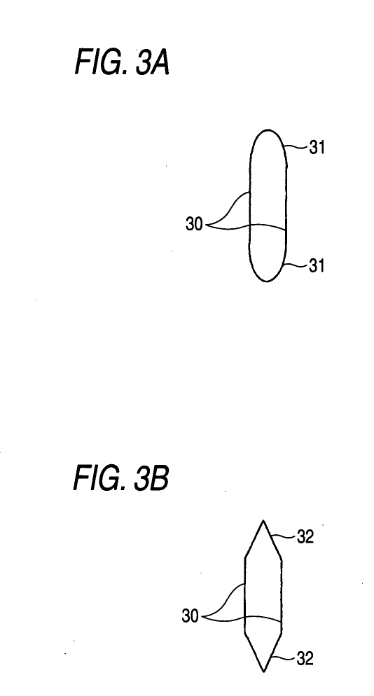

An explanation will be given as follows of a preferable condition of the die having the plurality of projected portions used in the invention in reference to FIG. 2. FIG. 2A is a plane view of the die viewed from a side of a projected pressure welding face, FIG. 2B is a sectional view of the die at A-A section orthogonal to a center line in a longitudinal direction of the projected pressure welding face.

(Shape of Projected Pressure Welding Face)

Various shapes of a circular shape, an elliptical shape, a rectangular shape, a polygonal shape are pointed out as a shape of a projected pressure welding face 22, that is, a face of a surface of a projected portion 21 orthogonal to a direction of pressing of a die 20. Among these, it is preferable that the shape of the projected pressure welding face 22 is a shape having a longitudinal direction and a converged end portion. As a specific example of such a shape, there is pointed out an oval shape comprising a linear line portion 30 and a circular arc portion 31 or a ship-like shape comprising a linear portion 30 and a pointed shape portion 32. Further, all of sizes of the respective projected pressure welding faces 22 may be same as each other, or differ from each other.

(Front End Width of Projected Portion)

It is preferable that a front end width w of the projected portion 21 satisfies w=t through 5t. Here, a thickness of the overlapped portion overlapped with the first member and the second member in an up and down direction is designated by notation t. When less than a lower limit, an area of the overlapped portion compressed by the projected portion is reduced, and a sufficient bonding strength tends not to be achieved. When an upper limit is exceeded conversely, in a section in the width direction of the overlapped portion compressed by the projected portion, a portion having a thin thickness is made to be continuous, a mechanical strength at a bonding portion is reduced, and the bonding portion tends to be easy to break at the section in the width direction.

Further, it is preferable to set the front end width w of the projected portion 21 such that a total width of a bottom portion of a cold pressure welded mark becomes equal to or smaller than 50% of a width of the overlapped portion (width of lead member) in the section in the width direction of the lead member at the overlapped portion.

At a portion formed with the pressing welding mark, the thickness is thinned by compressing the metal material. Therefore, when a large portion formed with the pressing welding mark is occupied in the section in the width direction of the overlapped portion, a mechanical strength of a bonding portion against tension or vibration is reduced and the bonding portion is easy to be destructed. Therefore, when the total width of the bottom portion of the cold pressure welded mark is equal to or smaller than 50% of the width of the overlapped portion, breakage can be restrained. Further, it is preferable that a lower limit value of the rate is about 30%.

(Interval of Contiguous Projected Portions)

When pressure welding is carried out, an interval between the projected portions 21 of the die 20 is determined in consideration of a deformation influence of the overlapped portion compressed by the projected portion 21, and pressure welding is carried out by the die having a pertinent interval of the projected portions. It is preferable that an interval p between contiguous projected portions 21 satisfies w/p=0.3 through 0.5 in a relationship with the front end width w of the projected portion 21. Here, the interval p between the contiguous projected portions refers to a distance between centers of the projected pressure welding face 22 contiguous to each other. When less than a lower limit of the regulated range, it is difficult to achieve a sufficient bonding strength. When an upper limit thereof is exceeded conversely, contiguous cold pressure welded marks are liable to interfere with each other.

(Slope of Projected Side Face)

The die 20 having the projected portion is constituted by a base bottom portion 23 and the projected portion 21 projected from the base bottom portion 23. Normally, the base bottom portion 23 is formed by a planar shape. It is preferable to constitute the projected portion 21 to spread out from the pressure welding face 22 to the base bottom portion 23. Therefore, it is preferable that a slope a of a projected side face 24 (an angle made by a line orthogonal to a plane of the base bottom portion 23 and a contour line of the projected side face 24) satisfies 0 through 30°. The angle is further preferably 10 through 20°. By using the die having such a slope, the following effect can be achieved.

(1) The die can be restrained from being deformed by a press force in pressure welding.

(2) Bonding having a high strength can firmly be carried out by facilitating to deform the overlapped portion by the projected portion in pressure welding.

(Height of Projected Portion)

It is preferable that a height h of the projected portion 21 satisfies h>0.8 t. When compressed by the die having such a height, a pressure preferable for subjecting the overlapped portion to pressure welding is easy to be applied, and bonding can be carried out further firmly.

(Length of Projected Portion)

It is preferable that a length L of the projected portion 21 satisfies L=5t through 10t. When less than a lower limit, the area of the overlapped portion compressed by the projected portion is reduced, and the sufficient bonding strength tends not to be achieved. When the upper limit is exceeded conversely, the lap margin is prolonged, and therefore, the length is not preferable.

(Inclination of Projected Portion)

It is preferable that an inclination β of the projected portion 21 (an angle made by a line orthogonal to a width direction of the die 20 and a center line in the longitudinal direction of the projected pressure welding face 22) satisfies 0 through 45°. In a case that the length of the projected portion 21 is constant, when β=0°, the lap margin becomes the longest, and the lap margin is shortened as increasing β. When an upper limit is exceeded, a portion having a thin thickness is made to be continuous in the section in the width direction of the overlapped portion compressed by the projected portion, the mechanical strength at the bonding portion is reduced, and the portion tends to be easy to break.

(Arrangement of Projected Portion)

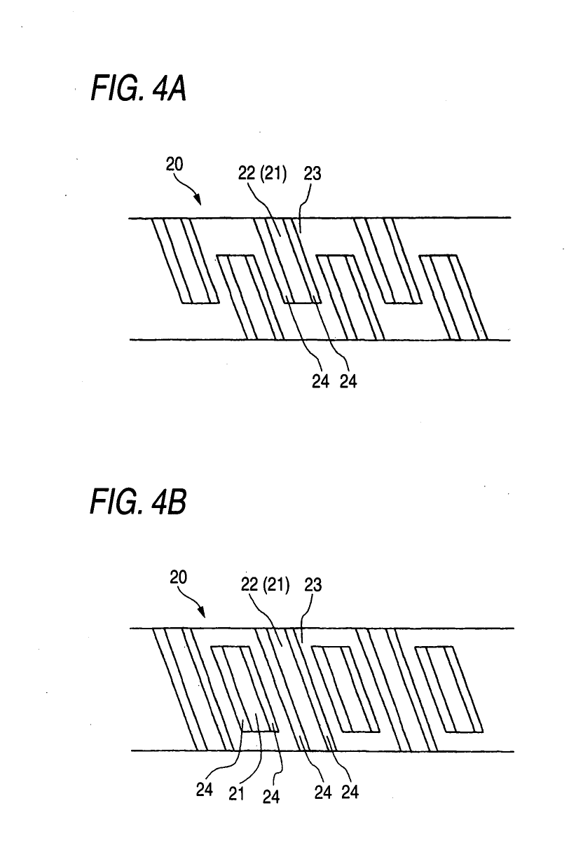

As arrangement of the projected portion, there is conceivable an arrangement thereof for arranging the projected portions having the same shape of the pressure welding face in parallel in the width direction as shown by FIG. 2A in view from a side of the projected pressure welding face of the die, further, arranging the projected portion 21 in a zigzag shape in the longitudinal direction (refer to FIG. 4A), or arranging the projected portions 21 having different sizes of the pressure welding faces 22 in parallel in the width direction of the die (refer to FIG. 4B). Thereby, both end portions of the cold pressure welded mark on which a stress is easy to be concentrated and which is easy to constitute an onset of breakage by tension or vibration can be shifted in the longitudinal direction, and the bonding strength can be increased.

### <Pressure Welding Condition>

(Pressure Welding Position)

It is preferable to compress a region of the overlapped portion on an inner side from an outer edge thereof by a certain width or more with the projected portion 21. The certain width in this case is made to be twice as much as a thickness of a thinner one of the first member or the second member. When a vicinity of the outer edge of the overlapped portion is compressed by the projected portion, there is a case in which the outer edge is deformed to bulge to an outer side, and in an extreme case, the outer edge is cracked. The limitation of the pressure welding position is particularly effective when the thickness of the overlapped portion is equal to or larger than 1 mm. When the thickness of the overlapped portion is less than 1 mm, there is case in which a region more proximate to the outer edge can be compressed by the projected portion.

(Face Pressure)

In pressure welding, normally, a press having a press force of 58839 through 78453 N (6000 through 8000 kgf) is used. In this case, it seems that pressure welding can be carried out by making a face pressure (press force/contact area of die) equal to or lager than 980 MPa (100 kgf/mm²). In finishing to compress the die 20, normally only the pressure welding face 22 of the die projected portion presses the overlapped portion, and therefore, the contact area of the die is constituted by a total area of the pressure welding face 22.

### <Cold Pressure Welded Mark>

A cold pressure welded mark of a recess shape is formed by compressing the overlapped portion by the die having the projected portion and the plane die, or by dies having the projected portions to be subjected to cold welding. A shape of the cold pressure welded mark becomes the shape transcribed with a shape of the projected portion of the die. At a surrounding of the formed cold pressure welded mark, there is observed a built-up portion formed by escaping a portion of the metal material of the portion compressed by the projected portion. Therefore, the surrounding of the cold pressure welded mark becomes thicker than the thickness of the overlapped portion before pressure welding, a depth of the cold pressure welded mark is deep, and a step between a recess and a projection of the surface of the overlapped portion is large.

### <Plastic Working to Cold Pressure Welded Mark>

Plastic working is carried out to decease the thickness of the overlapped portion after forming the cold pressure welded mark by subjecting the overlapped portion to pressure welding. By the plastic working to the thickness direction of the overlapped portion, the surface of the overlapped portion is flattened, and there is formed a deformation mark constituted by a flattering step of reducing a depth of the cold pressure welded mark by plastically working the overlapped portion in a thickness direction thereof.

(Plastic Working (Flattening Step))

In the plastic working, it is conceivable to compress the overlapped portion by, for example, a pair of plane dies. At this occasion, it is preferable to compress the overlapped portion to make the thickness equivalent to the thickness of the overlapped portion before being subjected to pressure welding.

### <Deformation Mark>

The deformation mark is a mark produced at the first member and the second member by the plastic working in the thickness direction of the overlapped portion. Although there are various modes in the deformation mark, as a representative example thereof, there is pointed out the deformation mark wherein a depth of the cold pressure welded marks in the recess shape is reduced by plastic working the overlapped portion in a thickness direction thereof. There is another deformation mark which constitutes a plane portion formed by compressing the built-up portion in a bent shape formed at the surrounding of the cold pressure welded mark. By the plane portion, the stepped difference between the recess and projection of the surface at the overlapped portion is reduced, and the surrounding of the cold pressure welded mark is flattened. Further, as another deformation mark, there is pointed out a deformation mark constituted by reducing the width of the cold pressure welded mark by compressing the built-up portion of the surrounding of the cold pressure welded mark. As still other deformation mark, there is pointed out a deformation mark constituted by deforming the cold pressure welded mark to reduce the width and forming the bottom portion of the cold pressure welded mark by a wavy shape. Normally, the wavy shape is a shape of bending the bottom portion in a W shape when viewed in the section. A recess in correspondence with a center of the bottom portion in the W shape is formed at a lower side of the overlapped portion (face compressed by plane dies in cold welding).

By forming the deformation mark, when a corrosion resistant member, mentioned later is coated on an outer periphery of the overlapped portion, a defect of a cavity or the like is difficult to be produced between the corrosion resistant member and the overlapped portion, and the corrosion resistant member is easy to be brought into close contact with the surface of the overlapped portion.

### <Combination of Dies Having Pluralities of Projected Portions>

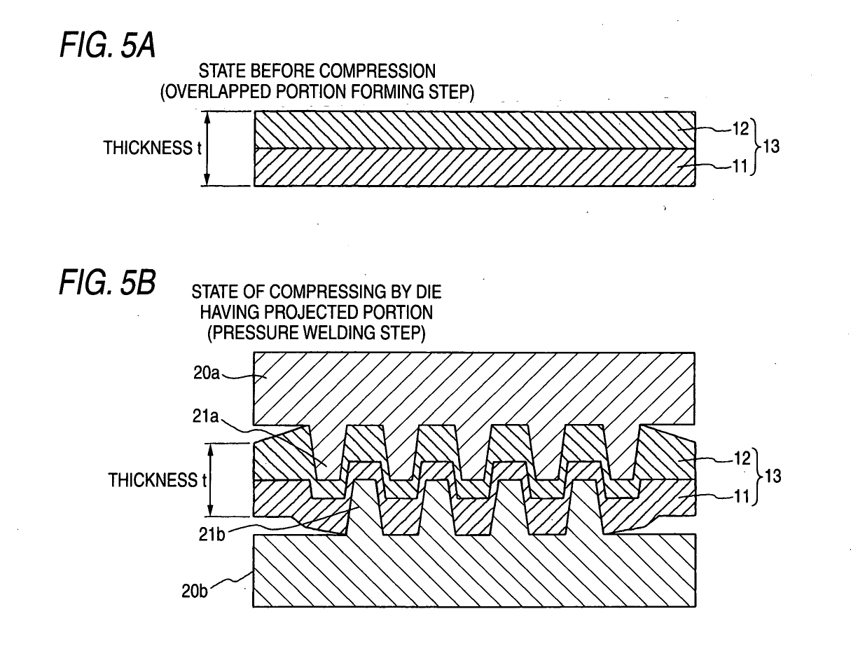

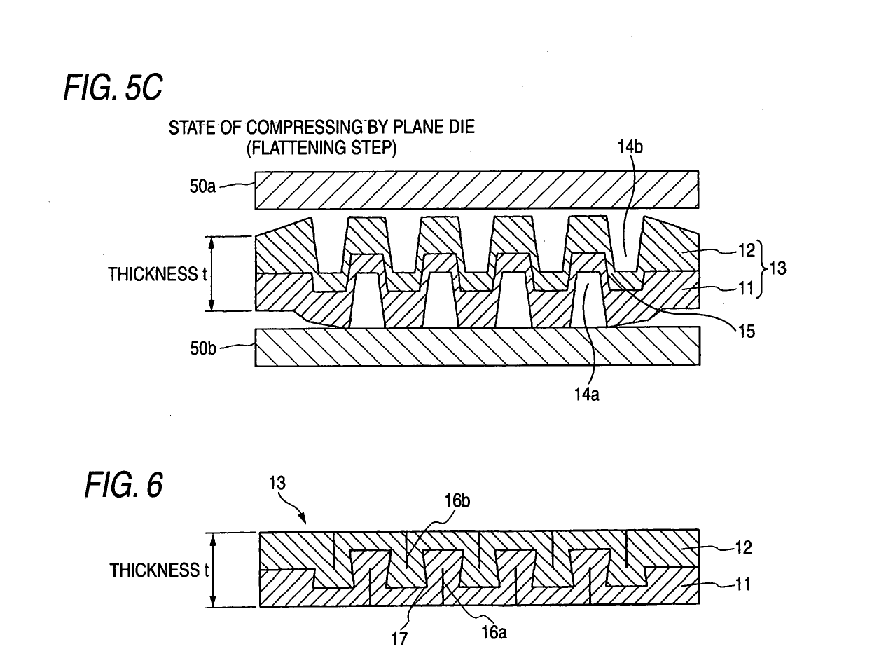

FIG. 5 illustrates views for explaining an example of compressing the overlapped portion of the first member and the second member by a combination of dies having pluralities of projected portions. FIG. 5A shows a sectional view in the width direction of the overlapped portion 13 of the first member 11 and the second member 12, showing a state before being subjected to pressure welding.

In the case of the combination of the dies having the pluralities of projected portions, it is preferable to compress the overlapped portion 13 in a state in which the projected portions of the respective dies are shifted from each other, that is, a projected portion 21a of one die 20a and a projected portion 21b of other die 20b are brought in mesh with each other (refer to FIG. 5B). Cold pressure welded marks in a deep recess shape on an upper face side and a lower face side are formed on the overlapped portion 13 compressed by the combination. That is, respective surfaces of the first member 11 and the second member 12 are formed with a first cold pressure welded mark 14a and a second cold pressure welded mark 14b (refer to FIG. 5C), and the second cold pressure welded marks 14b are aligned at positions in correspondence with intervals of the first cold pressure welded marks 14a in the section in the width direction of the overlapped portion 13.

In the case of the combination of the dies having the pluralities of projected portions, when the overlapped portion is compressed, a corner portion of the projected portion of the one die and a corner portion of the projected portion of other die brought in mesh with the projected portion are made to be proximate to each other to some degree when the portion is made to constitute the thinnest portion 15 of the overlapped portion 13.

In plastic working after subjecting the overlapped portion 13 to pressure welding, for example, the overlapped portion 13 is compressed by a pair of plane dies 50a, 50b (refer to FIG. 5C). It is preferable to compress the overlapped portion in the thickness direction such that a thickness of the overlapped portion becomes equivalent to the thickness of the overlapped portion before pressure welding.

The overlapped portion further subjected to plastic working after pressure welding is formed with closed marks 16a, 16b on an upper face side and a lower face side (refer to FIG. 6). The closed mark is formed by deforming to close the first cold pressure welded mark 14a and the second cold pressure welded mark 14b by compressing the built-up portions at surroundings of the cold pressure welded marks. This is because since the thinnest portion 15 is weak in view of a strength, thick-walled portions disposed on both sides thereof are deformed to be proximate to each other while being pressed in the thickness direction. Although FIG. 6 shows the closed marks 16a, 16b in a closed line shape such that inner side walls of the first cold pressure welded marks 14a and second cold pressure welded marks 14b are brought into contact with each other, actually, there are frequently constituted closed marks slenderly opened in a groove-like shape at a lower face of the first member 11 and an upper face of the second member 12. Further, by compressing by the plane dies 50a, 50b, there is formed an engaging portion 17 for mechanically fitting the first member and the second member between the two closed marks while forming the closed marks 16a, 16b. The engaging portion 17 is formed by widening the thick-walled portions disposed on the both sides of the thinnest portion 15 in a direction orthogonal to the compressing direction while being press. By forming the engaging portion 17, the first member and the second member are brought in mesh with each other to resist against exfoliation from each other, and therefore, a higher bonding strength can be achieved. The engaging portion may be constructed by a constitution of including a projected portion and a recessed portion brought in mesh with each other to resist against exfoliation from each other. For example, as the projected portion, there is pointed out a mode having a portion having a width wider than that of a root at a front end portion of the projected portion or a middle from the root of the projected portion to the front end. As the recessed portion, there is pointed out a mode which is constituted by a groove or a hole portion and in which the width of the opening portion is narrower than the width of the bottom portion or the width of the middle from the bottom portion to the opening portion. As a representative example of the engaging portion, as shown by FIG. 6, there is pointed out an engaging portion comprising a dovetail groove having a side wall inclined to the bottom face and a projected streak engaged with the dovetail groove.

### <Corrosion Resistant Member>

The corrosion resistant member is coated on the outer periphery of the overlapped portion in order to prevent water or the like from invading the overlapped portion of the first member and the second member comprising different kinds of metals. The corrosion resistance member also restrains corrosion by forming a local battery.

The corrosion resistant member includes a thermoplastic layer adhered to the outer periphery of the overlapped portion, and the thermoplastic layer comprises a thermoplastic polyolefin resin. As such a thermoplastic polyolefin resin, polyethylene, acid denatured polyethylene, polypropylene, acid denatured polypropylene (for example, maleic anhydride denatured polypropylene), a reactive resin of ionomer or the like or a mixture of these is preferable. Particularly, polypropylene or acid denatured polypropylene is preferable.

Further, the corrosion resistant member includes a bridging layer on an outer side of a thermoplastic layer. The bridging layer comprises bridged polyolefin resin. It is preferable to use a resin the same as thermoplastic polyolefin resin mentioned above for polyolefin resin. This is because when a resin different from thermoplastic polyolefin resin mentioned above is used, an adhering force between the thermoplastic layer and the bridging layer tends to reduce.

### <Nonaqueous Electrolyte Electricity Storing Device>

As a nonaqueous electrolyte electricity storing device, there is pointed out a nonaqueous electrolyte battery of, for example, a lithium ion battery or the like or a nonaqueous electrolyte capacitor of an electrical double layer capacitor. The nonaqueous electrolyte electricity storing device includes a nonaqueous electrolyte medium, and a nonaqueous electrolysis solution dissolved with an electrolyte (for example, lithium compound) in a nonaqueous solvent or a solid electrolyte comprising polyethylene oxide, polypropylene oxide or the like is used as the nonaqueous electrolyte medium.

(Constitution of Lithium Ion Battery)

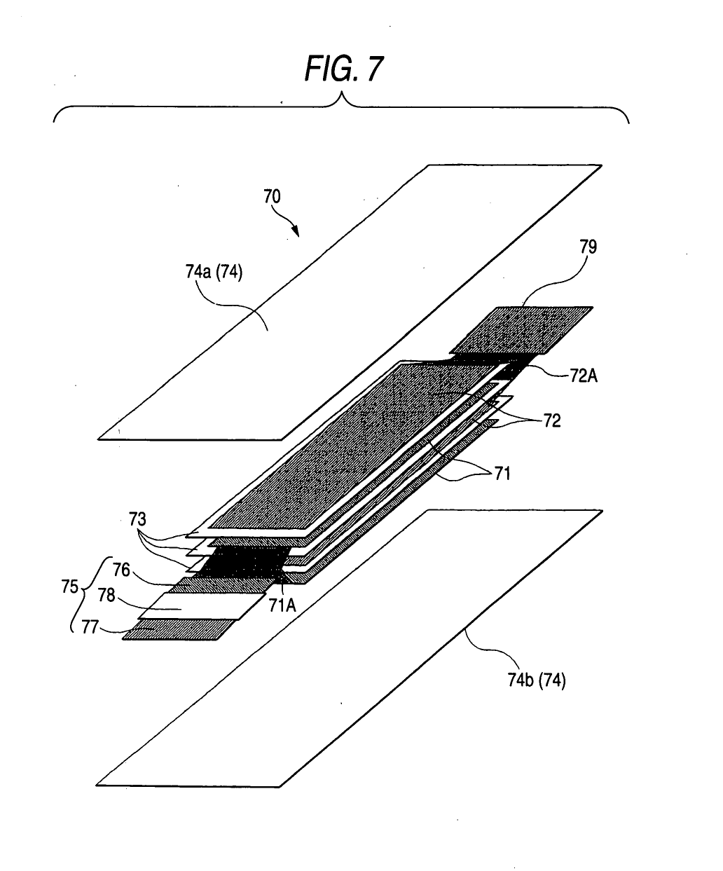

FIG. 7 is an outline constitution view showing an example of a lithium ion battery according to the invention. A lithium ion battery 70 has a constitution of containing an electrode group constituting a laminated layer structure by laminating a positive electrode 71 and a negative electrode 72 by way of a separator 73 along with an electrolysis solution at an inner portion of an external member 74 comprising a film. A lead member (positive electrode lead) 75 connected to the positive electrode 71 is led out from one side of the external member 74 to outside. Further, the lead member (negative electrode lead) 79 connected to the negative electrode 72 is led out from one side of the external member 74 on a side opposed to a side of leading out the positive electrode lead 75 to outside.

The positive electrode 71 and the negative electrode 72 are provided with a structure of forming an active substance layer on the metal base member of a metal foil or an expanded metal referred to as a connector, Al is used for the metal base member of the positive electrode 71, and Cu is used for the metal base member of the negative electrode 72. Further, each positive electrode 71 is connected with a connecting lead 71A, each negative electrode 72 is connected with a connecting lead 72A, and electricity from a plurality of the positive electrodes 71 or the negative electrodes 72 is made to be able to be summarized to the connecting lead 71A or 72A. Further, the connecting lead 71A is connected with the positive electrode lead 75, and the connecting lead 72A is connected with the negative electrode lead 79.

The external member 74 is constituted by two sheets of films 74a, 74b, and contains the electrode group or the like by laminating the films and subjecting an outer peripheral edge to heat seal. The film comprises a multiple layer film interposing a metal layer comprising, for example, Al by plastic layers.

The negative lead 79 is constituted by one sheet of a Cu plate having a material the same as that of the metal base member of the negative electrode 72, and the Cu plate is subjected to Ni plating.

The positive electrode lead 75 includes a first member 75 and a second member 77 and is constructed by a constitution the same as that of the lead member of the invention. The first member 76 is constituted by an Al plate having a material the same as that of the metal base member of the positive electrode 71, and the second member 77 is constituted by a Cu plate subjected to Ni plating the same as that of the negative lead 79. Further, a portion of overlapping the first member 76 and the second member 77 is arranged at outside of the external member 74, and an outer periphery of the overlapped portion is coated by a corrosion resistant member 78. It is preferable to make the corrosion resistant member 78 ride over an outer edge of the external member, that is, reach not only the portion of overlapping the first member 76 and the second member 77 but also to an inner side of the external member 74. When the corrosion resistant member 78 covers the portion of overlapping the first member 76 and the second member 77, the electric corrosion at the overlapped portion can be restrained thereby. By being extended further to the inner portion of the external member 74, the corrosion resistant member 78 is welded with the external member 74, and the external member prevents the electrolysis solution from being leaked from the portion of pinching the lead member 75.

In a case that a plurality of the batteries 70 are prepared to be connected in series, the second member 77 of the positive electrode lead 75 and the negative electrode lead 79 comprise metals having the same material, a local battery is not formed at the bonding portion of the second member 77 and the negative electrode lead 79 and bonding can easily be carried out.

(Mode of Connecting Batteries)

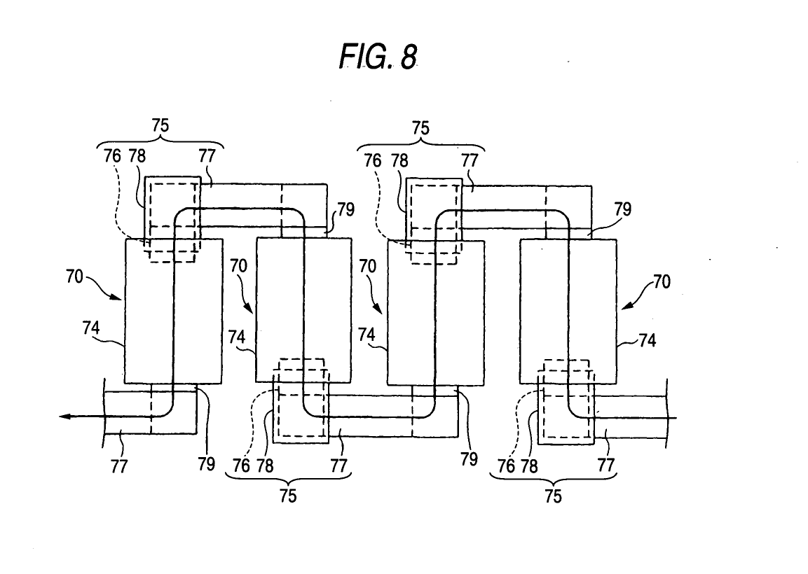

Next, an explanation will be given of a structure of connecting batteries having a constitution similar to that of the lithium battery shown in FIG. 7 in series in reference to FIGS. 8 to 11. In FIGS. 8 to 11, notations the same as those of FIG. 7 designate the same members, and an arrow mark indicates a direction in which a current flows.

When a battery set is constituted by connecting a plurality of batteries in series, there are conceivable not only a case of aligning to connect respective batteries in a vertical direction (in a linear line shape), but also a case of aligning the respective batteries in a horizontal direction and connecting the negative electrode leads 79 of the respective batteries 70 to the positive electrode leads 75 of other batteries. In the latter case, when the lead members are led out in a linear line shape from the respective batteries 70, in connecting the negative electrode leads 79 of the respective batteries to the positive electrode leads 75 of other batteries, it is necessary to prepare other additional leads in order to connect the two leads 75, 79. Hence, by arranging the first member 76 and the second member 77 in a nonlinear line shape, the positive electrode leads 75 and the negative electrode leads 79 can be connected directly without using the additional leads.

For example, when the respective batteries 70 are aligned in a horizontal direction and connected in series as shown by FIG. 8, the positive electrode leads 75 in a shape of being bent in an orthogonal direction are used. The respective batteries 70 use the positive electrode leads 75 of an L-like shape which is constituted by bonding the second members 77 constituting rectangular Cu plates to the first members 76 constituting rectangular Al plates in orthogonal directions as the positive electrode leads 75. The Al plate of the positive electrode lead 75 is connected to the positive electrode of the battery 70, and the Cu plate is extended to be prolonged to reach the contiguous negative electrode 79. The Al plate and the Cu plate of the positive electrode lead 75 are bonded by cold welding at portions thereof overlapped by each other, and a bonding portion thereof is covered by the corrosion resistant member 78. The corrosion resistant member 78 is welded not only to the portion of overlapping the first member 76 and the second member 77 but also to the external member 74 by being extended to the inner portion of the external member 74. Therefore, not only the portion of overlapping the first member 76 and the second member 77 can be prevented from being corroded but also the electrolysis solution can be prevented from being leaked from the portion of pinching the positive electrode lead 75 by the external member 74. On the other hand, a rectangular Cu plate is used as the negative lead 79.

By aligning the respective batteries 70 such that the positive electrode leads 75 of certain batteries overlap the negative leads 79 of the contiguous batteries 70, the Cu plates of the positive electrode leads 75 and the negative electrode leads 79 are bonded. The bonding can comparatively easily be carried out by various publicly-known methods owing to the same kind of metal. By the constitution, the positive electrode leads 75 and the negative electrode leads 79 of the contiguous batteries can directly be connected.

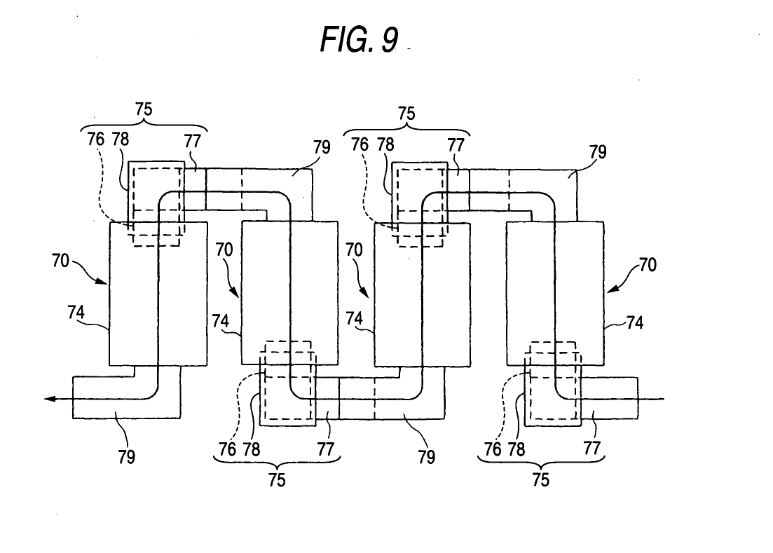

Further, as the modified example of the connecting structure of FIG. 8, as shown by FIG. 9, the negative lead 79 may be constituted by a Cu plate of an L-like shape. In that case, a direction of leading out the positive electrode lead 75 and a direction of leading out the negative electrode 79 in one battery are constituted by directions reverse to each other. For example, at the battery 70 at a left end of FIG. 9, the positive electrode lead 75 is led out to a right side, and the negative electrode lead 79 is led out to a left side. Even when such a negative electrode 79 is used, the positive electrode lead 75 and the negative electrode lead 79 can directly be connected without using an additional lead.

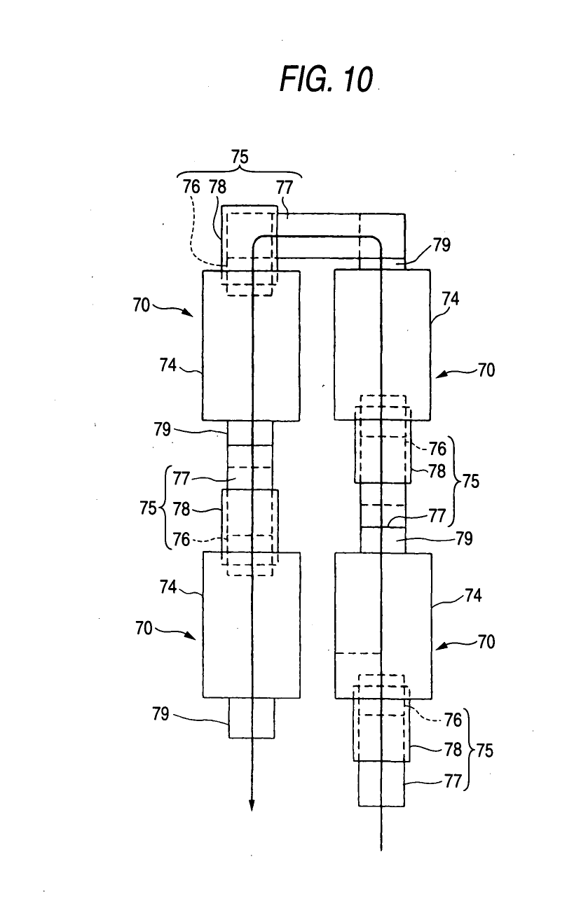

Otherwise, as shown by FIG. 10, the lead member of the invention in the L-like shape can be utilized also for a case of connecting a total of the batteries in series by aligning a battery group connected by being aligned in a linear line shape in the horizontal direction and connecting end portions of the respective battery groups. For example, according to the left upper battery 70 of FIG. 10, there is used the lead member in the L-like shape bonding the rectangular Cu plate (second member 77) to the rectangular Al plate (first member 76) in the orthogonal direction for the positive electrode lead 75, and the rectangular Cu plate is used for the negative lead 79. The Cu plate of the positive electrode lead 75 of the upper left battery is provided with a length of reaching the negative electrode lead 79 of the right upper battery. On the other hand, the right upper, right lower and left lower batteries 70 of FIG. 10 are made to constitute batteries using lead members aligning to connect the second members 77 constituting the rectangular Cu plates to the first members 76 constituting the rectangular Al plates in the linear line shape as the positive electrode leads 75 and using the rectangular Cu plates for the negative electrode leads 79. Further, the Cu plates of the negative electrode lead 79 of the right lower battery and the positive electrode lead 75 of the right upper battery are connected, the Cu plates of the negative electrode lead 79 of the right upper battery and the positive electrode lead 75 of the left upper battery are connected, and the Cu plates of the negative electrode lead 79 of the left upper battery and the positive electrode lead 75 of the left lower battery are connected. Thereby, all of the batteries can be connected in series without using the additional lead member.

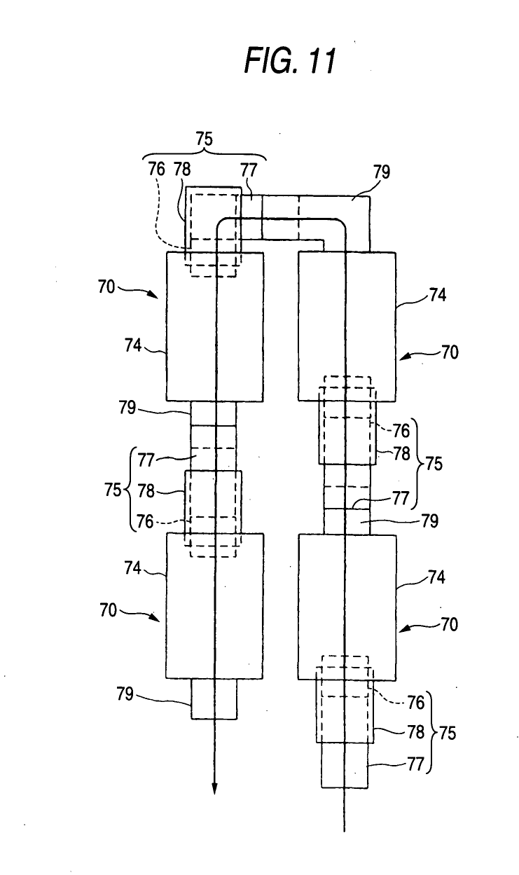

Further, as a modified example of the connecting structure of FIG. 10, as shown by FIG. 11, the negative electrode lead of a portion of the batteries may be constituted by a shape of being bent in the orthogonal direction. For example, the Cu plate of the L-like shape is used for the negative electrode lead of the right upper battery 70 of FIG. 11. The Cu plate in the L-like shape is led out in a direction of reaching the Cu plate of the positive electrode lead 75 of the left upper battery. Further, by connecting the Cu plates of the negative lead 79 of the right upper battery and the positive electrode lead 75 of the left upper battery and connecting other batteries similar to FIG. 10, the positive electrode leads and the negative electrode leads can be connected without using an additional lead.

(Electrical Double Layer Capacitor)

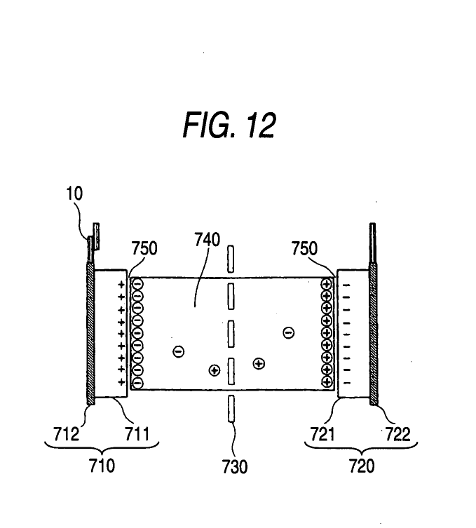

FIG. 12 shows an outline constitution view of an electrical double layer capacitor. Also an electrical double layer capacitor is constructed by a constitution of interposing a separator 730 between a positive electrode 710 and a negative electrode 720 dipped into an electrolysis solution 740 similar to a secondary battery. Activated carbon or carbon fiber is used for electrode materials 711, 721 of the positive electrode 710 or the negative electrode 720. Normally, the electrode material is molded in a sheet-like shape by mixing a conductive member and a bridging member after carrying out an activation treatment for increasing a specific surface area. Further, the activated carbon in the sheet-like shape is bonded with metal base members (positive electrode base member 712, negative electrode base member 722). As a representative electrolysis solution used in a nonaqueous system, propylene carbonate or the like is pointed out.

In the capacitor, at an interface between the electrolysis solutions including ions and the electrode material having a large surface area, solvent and ions are regularly aligned, and layers having ion concentrations different from those of the electrolysis solution at a position remote from the electrodes are formed on a positive electrode side and a negative electrode side. The layers are electrical double layers 750. When an external power source is connected to the capacitor, densities of ions forming the double layers at the two electrodes are increased, as a result, a capacitor is charged.

Here, as lead members 10 connected to the metal base members 712, 722 of the two electrodes, lead members as shown by FIG. 1 are used. When the positive electrode base member 712 comprises Al and the negative electrode base member comprises Cu, the lead member 10 connected to the positive electrode may be constituted of a first member of Al and a second member of Cu.

According to the electrical double layer capacitor, only electrolyte ions are moved in the solution to be adsorbed or desorbed to and from the electrode interfaces in accordance with charging or discharging to physically accumulate electric charge. Therefore, different from accumulating electric charge by a chemical reaction by a general secondary cell, even when charging and discharging are repeated, a deterioration in a function thereof is extremely small, which can satisfy rapid charging and discharging.

### Embodiment 1

As a sample for pressure welding, an Al plate of 0.2 mm×50 mm×60 mm and a Ni plated Cu plate having the same size are prepared. The Al plate and the Ni plated Cu plate are partially overlapped, and an overlapped portion thereof is subjected to cold pressure welding. A dies consisted of a die having a projected portion and a plane die are used in pressure welding. In the dies, there are 3 kinds of modes for the die having the projected portion. A first one is a straight die. The die is a die for pressing the overlapped portion in a linear line shape in a width direction. A second die is a lengthwise teeth die. The die is constituted by a shape of aligning a plurality of the projected portions in an oval-like shape, and the respective projected portions are aligned such that a longitudinal direction thereof is in line with a longitudinal direction of the lead member. A third one is an inclined teeth die. The die is constituted by a shape of aligning a plurality of the projected portions in a shape of a parallelogram, and the respective projected portions are aligned such that a longitudinal direction thereof is inclined to the longitudinal direction of the lead member.

Specifications of respective dies are as follows.

(Straight Die)

height of projected portion: 1.0 mm

width of projected portion: 1.5 mm

length of projected portion: 40 mm

number of projected portions: 1 piece

(Lengthwise Teeth Die)

height of projected portion: 1.0 mm

front end width of projected portion: 0.5 mm

length of projected portion: 3.2 mm

number of projected portions: 32 pieces

(Inclined Teeth Die)

height of projected portion h: 1.0 mm

front end width of projected portion w: 0.5 mm

length of projected portion L: 3.2 mm

interval between contiguous projected portions p: 1.4 mm

inclination of projected portion β: 30°

slope of projected portion side face α: 15°

number of projected portions: 30 pieces

By using the above-described respective dies, samples are arranged such that the Ni plated Cu plates are disposed on an upper side and the Al plates are disposed on a lower side, and the die having the projected portions is arranged on upper sides of the samples and the plane die is arranged on lower sides thereof.

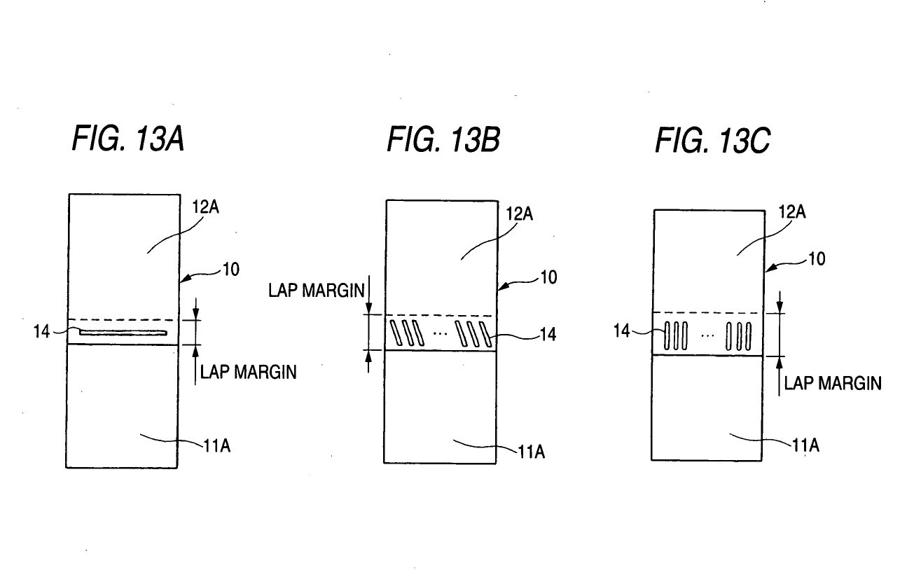

FIG. 13 shows plane views of lead members subjected to cold pressure welding by the respective dies. FIG. 13A shows the lead member 10 subjected to pressure welding by the straight die, FIG. 13B shows the lead member 10 subjected to pressure welding by the lengthwise teeth die, FIG. 13C shows the lead member 10 subjected to pressure welding by the inclined teeth die. All thereof are formed with cold pressure welded marks 14 in shapes constituted by transcribing the projected portions of the respective dies at the overlapped portions of the Ni plated Cu plates 12A and the Al plates 11A. It can be recognized that a length of overlapping the Ni plated Cu plate 12A and the Al plate 11A (lap margin) is the smallest in the straight die, next small in the inclined die, and the largest in the lengthwise teeth owing to shapes thereof.

First, pressure welding is carried out by a face pressure 1200 MPa, and a tensile test is carried out for the provided lead members. An evaluation standard in this case is determined by achieving 80% or more of a tensile strength of the Al plate. As a result, all of them satisfies the evaluation standard, but the lead member subjected to pressure welding by the straight die is to a degree of slightly exceeding the evaluation standard, and therefore, it is predicted that the lead member is broken at the portion of the thin-walled cold pressure welded mark made to be continuous in the width direction of the lead member. On the other hand, both of the samples subjected to the cold pressure welding by the lengthwise teeth die and the inclined teeth show tensile strengths which are larger than that of the sample subjected to the cold pressure welding by the straight die by 20% or more. Further, it seems that according to the samples subjected pressure welding by the lengthwise teeth die and the inclined teeth die, pluralities of the cold pressure welded marks are aligned at intervals in the width direction of the lead member, and therefore, there is hardly a concern of breakage as in the straight die.

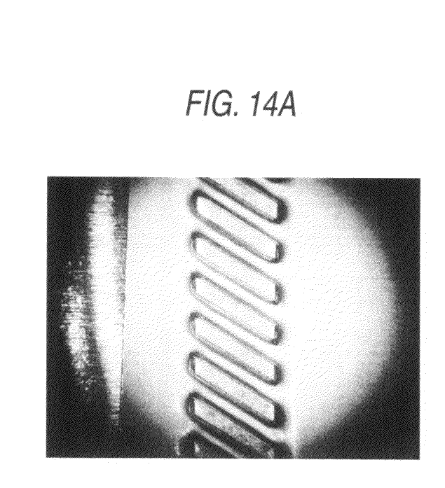

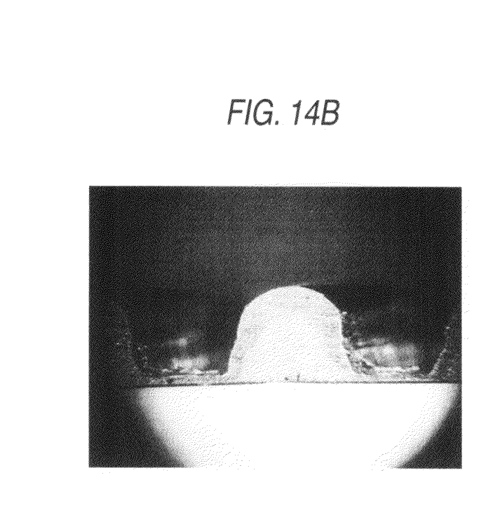

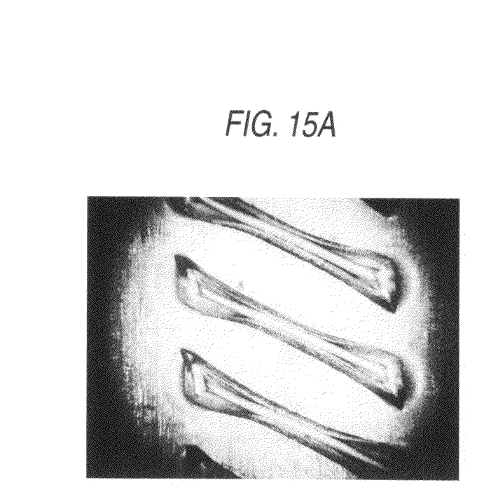

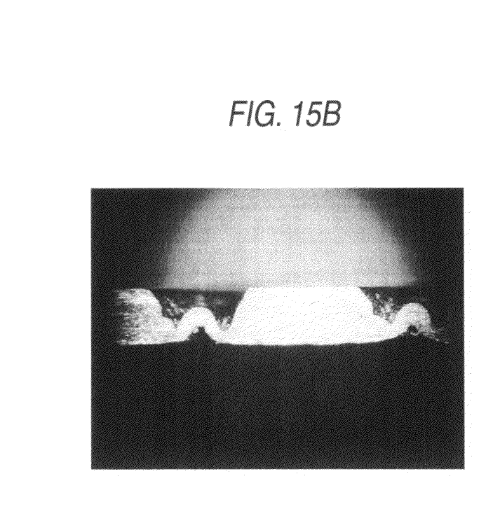

Next, the pressure welding portion of the sample subjected to the cold pressure welding by the inclined teeth die is further flattered by a pair of plane dies and states of the cold pressure welded mark before and after flattering are observed. Here, as a condition of flattening, a face pressure is made to be 1200 MPa, and a thickness of the cold welded portion after flattening substantially becomes a thickness of the sample before cold welding. FIG. 14 shows a photograph of a cold welding portion before flattening and FIG. 15 shows a photograph of the cold welded portion after flattening.

FIG. 14A is a plane view viewing a surface of Ni plated Cu and it is can be recognized that cold pressure welded marks in a recess shape in a shape of a parallelogram transcribed with the projected portions of the die are aligned. At that occasion, when a section of the cold pressure welded mark is observed, as shown by FIG. 14B, a portion pressed by the projected portion becomes very thin, and it can be recognized that a portion disposed between the projected portion becomes thicker than the thickness of the sample before cold welding by bulging to deform the sample to the upper side.

On the other hand, FIG. 15A is a plane view viewing the surface of the Ni plated Cu plate and it can be recognized that a width of an opening of the cold pressure welded mark is reduced at a middle portion in a longitudinal direction of the cold pressure welded mark. That is, by flattening, the cold pressure welded portion is deformed in a direction of closing the opening width of the cold pressure welded mark, and a closed mark is formed by narrowing the opening width. However, a reduction in the width is hardly observed at both end portions of the cold pressure welded mark. At this occasion, when a section of the cold pressure welded mark is observed, as shown by FIG. 15B, the bottom portion of the cold pressure welded mark is deformed in a W-like shape, and in other words, the deformation mark by flattening is recognized. That is, by deforming to narrow the width of the bottom portion of the cold pressure welded mark, even in observing from the surface side of the Al plate, a slender recessed portion in a groove-like shape is formed. Further, a portion of the surface of the sample disposed between the projected portions of the die becomes a flat face, and a thickness thereof is substantially equal to the thickness of the sample before pressure welding. The flat face is also one of the deformation marks by flattening.

Further, with regard to respectives of the sample subjected to cold pressure welding by the inclined teeth die which is flattened and the sample subjected to cold pressure welding by the inclined teeth die which is not flattened, the overlapped portions of the first members and the second members are coated by a corrosion resistant member and states of sections of the coated portions are observed. Aplastic sheet comprising a bridging layer and a thermoplastic layer is used for the corrosion resistant member. The bridging layer comprises maleic anhydride denatured polypropylene bridged by irradiation, and the thermoplastic layer comprises maleic anhydride denatured polypropylene. The bridging layer and the thermoplastic layer are previously thermally laminated to paste together and the laminated sheet is welded by hot press.

As a result, according to the sample which is subjected only to the cold welding, the thickness of the cold welding portion becomes larger than the thickness of the sample before cold welding, a portion between the cold pressure welded marks is constituted by a shape of bulging a bent face, and therefore, a contact area between the corrosion resistant member and the lead member is small. In contrast thereto, in the sample subjected to flattening, it can be recognized that the width of the cold pressure welded mark is reduced particularly at the Ni plated Cu surface, the flat face is formed, and therefore, the contact area between the corrosion resistant member and the lead member is sufficiently ensured.

### Embodiment 2

Next, the shape of the inclined teeth die used in Embodiment 1 is changed and cold welding and flattening similar to those of Embodiment 1 are carried out by the die. The die used in the example is a ship-like shape die in which both ends of the projected portion are formed in a converging shape. The die is similar to the inclined teeth die in other specification except that the both end portions of the projected portion are formed in the converging shape.

When cold welding is carried out by using the ship-like shape die, a cold pressure welded mark is similar to that of the inclined teeth die in a mode of transcribing the shape of the projected portion of the die. However, after flattening is carried out, it can be recognized that the opening width of the cold pressure welded mark is reduced not only at the middle portion in the longitudinal direction of the cold pressure welded mark but also substantially over an entire length thereof. Therefore, it seems that in the case of using the ship-like shape die rather than the inclined teeth die, the area of the flat face after having being flattened is wider, which is excellent in adhering performance of the corrosion resistant member.

### Embodiment 3

Next, the lead member of the invention by cold welding and a lead member for comparison by ultrasonic welding are fabricated and a tension resistant property and an electric property of the both are investigated.

Also in this case, a Ni plated Cu plate and an Al plate similar to those of Embodiment 1 are prepared and an overlapped portion thereof is subjected to cold welding or ultrasonic welding. A die used in cold welding is a die the same as the inclined teeth die in Embodiment 1. On the other hand, the ultrasonic welding is carried out by constituting bonding areas as 12 mm×3 mm×2 portions. Further, a sample subjected to cold welding is flatten by a pair of plane dies. Also the flattening condition is similar to that of the working condition of Embodiment 1.

The tension resistant property is measured by holding both ends of the provided lead member by a tensile tester and constituting a bonding strength by a tension at a time point of exfoliating the Ni plated Cu plate and the Al plate.

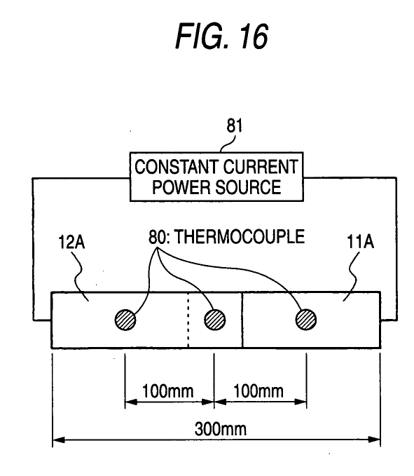

As shown by FIG. 16, the electric property is measured by arranging thermocouples 80 at a total of three portions of a position of the Ni plated Cu plate 12A of the lead member, a bonding position, and a position of the Al plate 11A, connecting a constant current power source 81 to both ends of the lead member and investigating temperature rise tendencies of the respective portions when a current of 200 A is conducted.

As a result of the test, it can be recognized that whereas the tension resistant property is about 60 kgf in the sample by cold welding and flattening, the property is about 40 kgf in the sample by ultrasonic welding, and it can be recognized that the former is more excellent in the tension resistant characteristic remarkably. It is predicted that this is because whereas in ultrasonic welding, the large portion of Al is bonded to the Ni plated layer, in cold welding, Al and Cu are directly bonded.

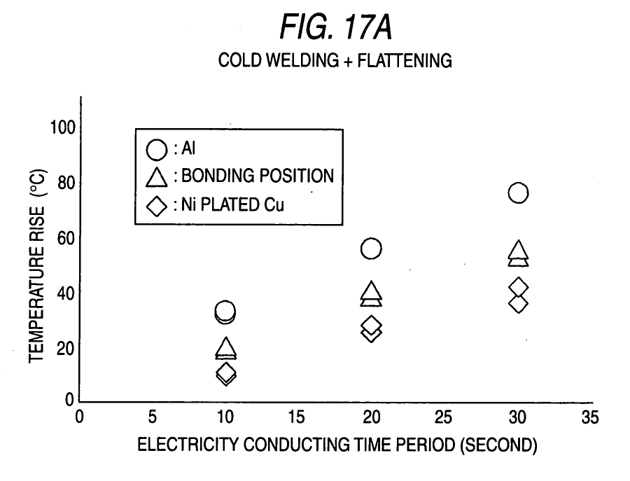

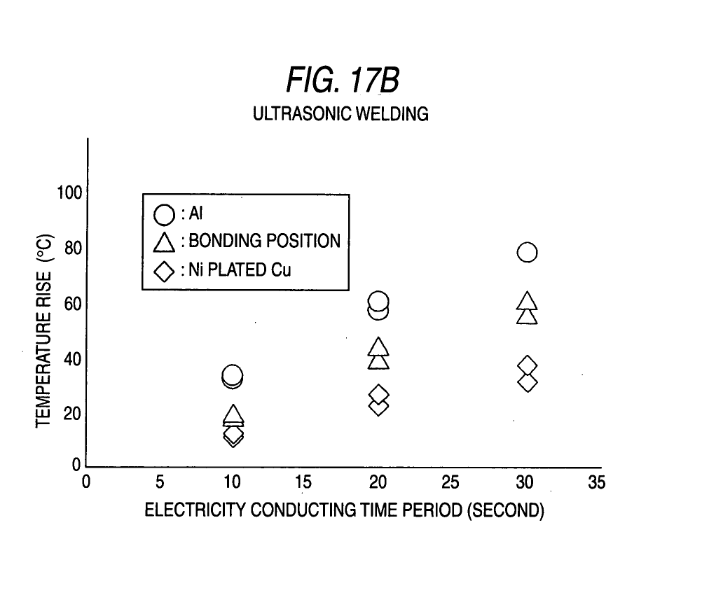

On the other hand, a result of measuring the electric property is shown in graphs of FIG. 17. Here, two samples are prepared and a result of measuring temperatures of the above-mentioned positions once for the respectives is shown. FIG. 17(a) of the drawing is a graph showing a relationship between a time period conducting electricity to the sample and a temperature rise of samples subjected to cold welding and flattening, FIG. 17(b) is a graph of the relationship of the sample subjected to ultrasonic welding.

It can be recognized that in any of the cases, the temperature is the lowest at the position of Ni plated Cu having a high conductivity, the temperature is the highest at the position of Al having a low conductivity, and the temperature at the bonding position is a temperature substantially a middle of the both temperatures. That is, an increase in a bonding resistance at the bonding position is hardly recognized. Further, when the temperature rise is compared between the sample subjected to cold welding and the sample subjected to ultrasonic welding, according to the temperature rise at the bonding position, the former is slightly lower than the latter. Therefore, it can be recognized that the lead member of the invention subjected to cold welding and flattening is provided with a function to be equivalent or higher than that of the lead member subjected to ultrasonic welding in view of the electric property.

The lead member according to the invention can be utilized preferably in an electricity storing device of a battery, an electrical double layer capacitor or the like.

Further, the electricity storing device of the invention is expected to be utilized as a power source of an electric vehicle, a hybrid vehicle or the like, or a dispersed power source in a building, a general household or the like, an electric storage of wind power or solar power generation, a power source of an electric appliance, an industrial apparatus or the like.

What is claimed is:

1. A lead member comprising:
a first member electrically connected to an electrode, and
a second member bonded to the first member at a position remote from the electrode and comprising a material different from a material of the first member, wherein
the first member and the second member overlap with each other,
an overlapped portion thereof are provided with a plurality of cold pressure welded marks in a recess shape formed by cold pressure welding, and
each of the cold pressure welded marks is formed with a deformation mark wherein a depth of the cold pressure welded marks in the recess shape is reduced by plastically working the overlapped portion in a thickness direction thereof.

2. The lead member according to claim 1, wherein
end portions of all of the cold pressure welded marks are arranged in parallel to be aligned in a width direction of the lead member.

3. The lead member according to claim 1, wherein
both end portions of at least a cold pressure welded mark is shifted from both end portions of another cold pressure welded mark in a longitudinal direction of the lead member.

4. The lead member according to claim 3, wherein
the respective cold pressure welded marks are arranged in a zigzag shape in the longitudinal direction of the lead member.

5. The lead member according to claim 3, wherein
the respective cold pressure welded marks are constituted by shapes having longitudinal directions, and
the cold pressure welded marks having different lengths in the longitudinal directions are alternately aligned in the width direction of the lead member.

6. The lead member according to claim 1, wherein
the respective cold pressure welded marks are constituted by shapes having longitudinal directions, and
the longitudinal directions of the respective cold pressure welded marks are inclined to a longitudinal direction of the lead member.

7. The lead member according to claim 1, wherein
the deformation mark is formed in a wavy shape of a bottom portion of the cold pressure welded mark in a section of the overlapped portion.

8. The lead member according to claim 1, wherein
the cold pressure welded marks include a first cold pressure welded mark on a surface of the first member and a second cold pressure welded mark on a surface of the second member,
the deformation marks include first closed marks of the first cold pressure welded marks and second closed marks of the second cold pressure welded marks, the second closed marks being provided at positions in correspondence with intervals between the first cold pressure welded marks, and
an engaging portion is provided on the interval between the first closed marks and the second closed marks, for mechanically fitting the first member and the second member.

9. The lead member according to claim 1, further comprising:
an outer periphery of the overlapped portion coated with a corrosion resistant member, wherein
the corrosion resistant member includes:
a thermoplastic layer adhered to the overlapped portion and including a thermoplastic polyolefin resin, and
a bridging layer arranged on the thermoplastic layer and including a bridged polyolefin resin.

10. The lead member according to claim 1, wherein
a positive electrode comprises aluminum,
the first member comprises aluminum, and
the second member comprises copper.

11. The lead member according to claim 1, wherein
a negative electrode comprises copper,
the first member comprises copper, and
the second member comprises aluminum.

12. The lead member according to claim 1, wherein
the first member and the second member are bonded to form a nonlinear line shape.

13. A lead member bonding method for bonding a first member electrically connected to an electrode and a second member comprising a material different from a material of the first member,
the method comprising:
a step of overlapping the second member on the first member at a position remote from the electrode;
a step of subjecting an overlapped portion thereof to cold welding by a pair of dies at least one of which includes a plurality of projected portions to form a plurality of cold pressure welded marks in a recess shape on the lead members; and
a flattening step of reducing a depth of the cold pressure welded mark by plastically working the overlapped portion in a thickness direction thereof.

14. The method of bonding a lead member according to claim 13, wherein
the flattening step comprises compressing the overlapped portion by a plane die.

15. The method of bonding a lead, member according to claim 13, wherein
respectives of the dies include pluralities of projected portions, and
the cold welding step is carried out such that the projected portions of the respective dies are brought into a state of being shifted from each other.

16. A nonaqueous electrolyte electricity storing device, including a positive electrode, a negative electrode and a nonaqueous electrolyte medium contained in an external member, respective lead members electrically connected to respectives of the positive electrode and the negative electrode being led out from the external member to outside, wherein
at least one of the lead member according to claim 1 is used, and
tips of both leads from the external members comprise the same material.

17. The nonaqueous electrolyte electricity storing device according to claim 16, further comprising:
an outer periphery of the overlapped portion coated with a corrosion resistant member, wherein
the corrosion resistant member includes:
a thermoplastic layer adhered to the overlapped portion and including a thermoplastic polyolefin resin, and
a bridging layer arranged on the thermoplastic layer and including a bridged polyolefin resin, and
the corrosion resistant member is extended to a portion where the lead member and the external member are in contact with each other, and is welded to an inner face of the external member for preventing the nonaqueous electrolyte medium from leaking from the external member.
